(19) United States
(12) Patent Application Publication
(10) Pub. No.: US 2008/0276876 A1
(43) Pub. Date: Nov. 13, 2008

(54) Pet accessories

(76) Inventor: David Danby Hill, Devon (GB)

Correspondence Address: Melvin I. Stoltz, Esq., 51 Cherry Street, Milford, CT, 06460, US

(21) Appl. No.: 12/151,618

(22) Filed: May 8, 2008

(30) Foreign Application Priority Data
May 10, 2007 (GB) 0708955.0

(51) Int. Cl. A01K 5/01

(52) U.S. Cl. 119/61.56

(57) ABSTRACT

A pet accessory comprises a housing having means for attachment to a dog collar (10), the housing including a first compartment (15) within which there is a container (24) that can be filled with water and a second compartment (16) in which dry goods can be stored, the housing being formed as two parts that are hingedly connected together, and there being a compartment (15, 16) in each of the parts of the housing.

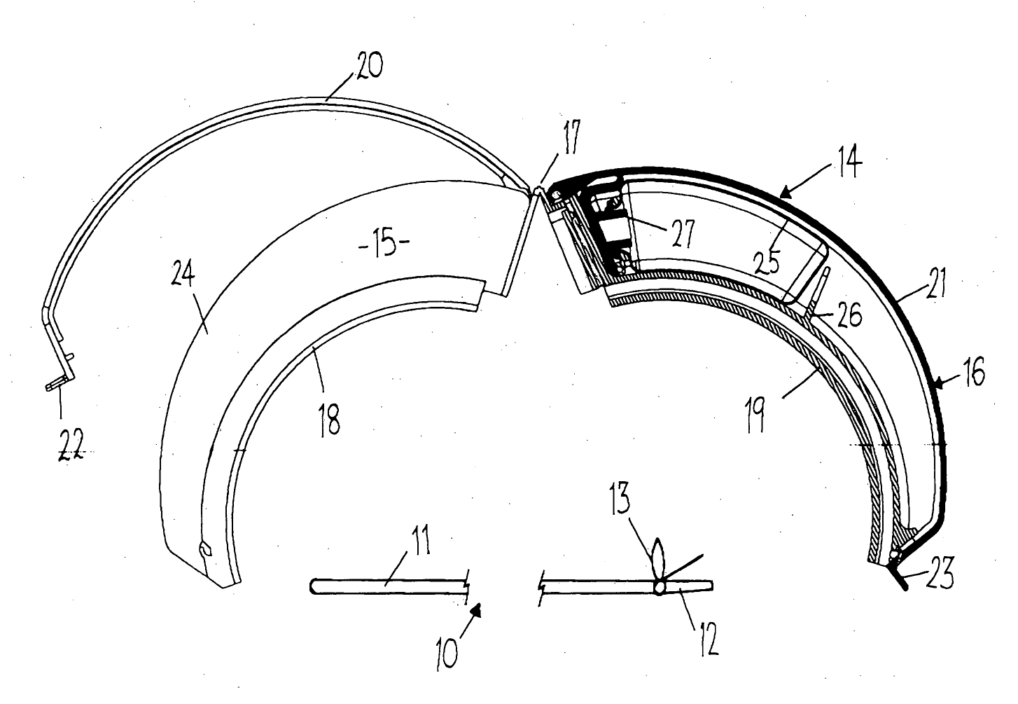

### FIELD OF THE INVENTION

This invention relates to pet accessories and, more particularly, to a device for enabling a dog owner to give his or her dog a drink during a walk or other exercise.

In US Patent Application No. 2006/065201 there is described a device comprising a combination dog collar and water reservoir adapted to worn around the neck of a dog. The reservoir contains a dispensing device connected to a combination stopper and telescopic cup.

The device described in the above US patent application does, however, have a number of disadvantages and it is an object of the present invention to overcome these disadvantages.

It is a further object of the present invention to provide a device for the purpose described above that also facilitates the collection of dog excrement.

### SUMMARY OF THE INVENTION

According to a first aspect of the present invention there is provided the combination of a dog collar and a pet accessory comprising a housing having means for attachment to the dog collar (or being attached to the dog collar), the housing including a first compartment within which there is a container that can be filled with water and a second compartment in which dry goods can be stored.

The housing is preferably formed as two parts that are hingedly connected together, there being a compartment in each of the parts of the housing. A pivotable flap is preferably provided for closing each of the compartments.

The container that can be filled with water preferably has an opening through which water can be introduced into the container and a cap that is arranged to have sealing engagement with said opening.

A disposable bowl may be provided for placing in one of the compartments, and a plurality of plastic bags may also be provided for placing in said compartment.

According to a second aspect of the present invention there is provided a pet accessory comprising a housing having means for attachment to a dog collar, the housing including a first compartment within which there is a container that can be filled with water and a second compartment in which dry goods can be stored, the housing being formed as two parts that are hingedly connected together, and there being a compartment in each of the parts of the housing.

### BRIEF DESCRIPTION OF THE DRAWING

The single FIGURE of the accompanying drawing shows a pet accessory and a dog collar.

### DESCRIPTION OF THE PREFERRED EMBODIMENT

The drawing shows a dog collar 10 comprising a flexible belt 11 and a buckle 12 to which a metal loop 13 is attached so that a lead (not shown) can readily be attached to the collar 10. The collar 10 shown in the drawing is thus a standard dog collar.

A pet accessory 14 is provided that is releasably attachable to the collar 10 and it comprises a housing that includes a pair of curvate plastic mouldings 15 and 16 that are interconnected by a hinge 17. The two plastic mouldings 15 and 16 are so shaped that they can fit around the neck of a dog and they include integral formations 18, 19 that define a “tunnel” to receive the belt 11.

A compartment is afforded within each of the plastic mouldings 15, 16 and access to each of the compartments is obtained by lifting an associated flap 20, 21 that terminates in an outwardly projecting flange 22, 23. An inwardly extending projection is provided adjacent the end of each flap 20, 21 and is arranged to engage in a corresponding recess in the main body of the associated moulding 15, 16.

Within compartment 15 there is, in one embodiment of the invention, a container 24 that fills substantially the whole of the interior of the compartment 15 and, within compartment 16, there is a container 25 that fills approximately half the interior of the compartment 16. In addition, within the compartment 16 and disposed substantially midway between the two ends thereof, there is an upstanding wall 26.

Each of the containers 24, 25 has an opening through which water can be introduced into the container and a cap 27 that is arranged to have sealing engagement with said opening.

That part of the interior of the compartment 16 on the side of the wall 26 remote from the container 25 is intended to receive dry goods. Such goods may include plastic bags, for the collection of dog excrement, a disposable bowl and dog treats. The container 25 will normally be used in hot weather when it is desirable to carry the maximum possible quantity of water but, if the weather is not particularly hot or if the dog is being taken out for a relatively short period of time, the container 25 may be omitted and additional dry goods may be placed in compartment 16.

In use of the pet accessory 14, the interior of the or each container 24, 25 is filled with water and the collar 10 is fastened around the neck of the dog, with the buckle 12 at the top, and with the hinge 17 interconnecting the two plastic mouldings 15, 16 at the bottom. If or when the dog owner decides to give his or her dog a drink, the flap 20 of the first compartment 15 will be moved into its open position and the container 24 will be taken out of the compartment 15. The flap 21 of the second compartment 16 will also be moved into its open position and the disposable bowl will be taken out of compartment 16. The cap 27 will be removed and water poured into the bowl.

The bowl is typically disposable, i.e. it will be used once only and then thrown away. This will avoid the build up of germs and bacteria.

The pet accessory will typically be sold with a supply of collapsible bowls for putting within the second compartment 16 and with a supply of bags (and possibly a replacement lead), again for putting within the second compartment 16.

More than one size of pet accessory will be provided. For example, a device designed for attachment to the collar of a Dalmatian will be significantly larger than that designed for attachment to the collar of a Yorkshire Terrier.

For a pet accessory designed for smaller dogs, no up-standing wall 26 may be provided and containers 24 may be placed in each of the compartments 15, 16. For a pet accessory designed for larger dogs, each compartment 15, 16 may be provided with an up-standing wall 26 and two containers 25 may be provided.

1. The combination of a dog collar and a pet accessory comprising a housing having means for attachment to the dog collar (or being attached to the dog collar), the housing including a first compartment within which there is a container that can be filled with water and a second compartment in which dry goods can be stored.

2. The combination claimed in claim 1, wherein the housing is preferably formed as two parts that are hingedly connected together, there being a compartment in each of the parts of the housing.

3. The combination claimed in claim 2, in which a pivotable flap is provided for closing each of the compartments.

4. The combination claimed in claim 1, in which the container that can be filled with water has an opening through which water can be introduced into the container and a cap that is arranged to have sealing engagement with said opening.

5. The combination claimed in claim 4, in which a disposable bowl is provided for placing in one of the compartments.

6. The combination claimed in claim 5, in which a plurality of plastic bags are provided for placing in said compartment.

7. A pet accessory comprising a housing having means for attachment to a dog collar, the housing including a first compartment within which there is a container that can be filled with water and a second compartment in which dry goods can be stored, the housing being formed as two parts that are hingedly connected together, and there being a compartment in each of the parts of the housing.

8. A pet accessory as claimed in claim 7, in which a pivotable flap is provided for closing each of the compartments.

9. A pet accessory as claimed in claim 8, in which the container that can be filled with water has an opening through which water can be introduced into the container and a cap that is arranged to have sealing engagement with said opening.

10. A pet accessory as claimed in claim 7, in which the two parts of the housing comprise plastic mouldings that include formations that define a tunnel to receive the dog collar.
